(19) United States
(12) Patent Application Publication
(10) Pub. No.: US 2011/0246256 A1
(43) Pub. Date: Oct. 6, 2011

(54) PRODUCT LIFECYCLE MANAGEMENT TECHNIQUES

(75) Inventor: Xinjie (Jay) Zhu, Palo Alto, CA (US)

(73) Assignee: Oracle International Corporation, Redwood Shores, CA (US)

(21) Appl. No.: 12/755,412

(22) Filed: Apr. 6, 2010

(51) Int. Cl. G06Q 10/00; G06F 17/30; G06F 3/048

(52) U.S. Cl. 705/7.23; 707/769; 715/771; 707/E17.014

(57) ABSTRACT

The present invention is directed to data management techniques that feature storing, on a computer system, storing on a computer system a data set arranged in a plurality of tables that correspond to multiple sections of a project, with each of the multiple sections defining properties of the project. A BOM resolution is produced by querying the data set in response to parameters of a BOM query that generates a resolved BOM. The resolved BOM includes a subgroup of the data in the data set, with the data outside of the subgroup corresponding to a revision associated with an item object that is included in the subgroup. Determined from the subgroup are the properties of the sections.

### BACKGROUND

The present invention generally relates to product lifecycle management and more particularly to tools that support product lifecycle management.

Product lifecycle management [PLM] is the process of managing development, design and manufacture of products. PLM integrates business resources to reduce the cost of products by, inter alia, decreasing the time required to develop products and resolve design conflicts. An important consideration with efficiently managing product lifecycle involves the use of a bill of materials.

A bill of materials (BOM) is a list of resources used to generate a product. The information included in a BOM is a function of both the product and the portion of the lifecycle in which the information pertains. For example, were the product an electronic system a related BOM may include information identifying a list of components used in the manufacturing of the system, e.g., a printed wiring board, or printed circuit board and the like. A BOM directed to a product that is a composition of matter would include information concerning a formula, as well as the constituent components used to make the formula, and the recipe for mixing the ingredients to produce the formula. A BOM directed to a service may contain information concerning the tasks to be performed, the duration of performing the tasks and travel time related to delivering the tasks. For complex systems and processes, several hundreds of BOMs may be implemented to include thousands of components and countless changes thereto over the lifecycle of the product being managed. To facilitate managing the vast quantity of information that may be associated with BOMs, several commercially available tools are available.

Oracle International Corporation, the assignee of the instant invention, provides product lifecycle management (PLM) solutions under the trade name Agile™ which is described as enabling companies to accelerate product innovation and maximize product profitability by managing the information, processes, and decisions about products throughout their lifecycles and across the global product network. With a broad suite of enterprise-class PLM applications and time-to-value focused implementations that are built on a proven track record of delivering value and enabling best practices across more than 1,300 global companies, Agile™ applications provide comprehensive end-to-end PLM solutions in the industry. Agile™ PLM solutions provide secure, timely, and accurate visibility and control of critical product information and processes to stakeholders at every stage in the product lifecycle.

SAP provides a software tool under the trade name Fourth Shift™ that is described as maintaining product structure information for the materials source, tools and reference items used to manufacture products.

Thus, there is a need for tools that facilitate management of bill of materials information.

### SUMMARY

The present invention is directed to data management techniques that feature storing, on a computer system, a data set arranged in a plurality of tables that correspond to multiple sections of a project, with each of the multiple sections defining properties of the project. A subset of the multiple sections provides descriptions of the properties defined by one of the multiple sections outside of the subset. A first of the plurality of tables includes item objects providing a description of the sections, and a second of the plurality of tables has change objects indicating variations made to the description. A third of the plurality of tables defines relationships between the change object and the item object in relation to a development sequence of the project. A BOM resolution is produced by querying the data set in response to parameters of a BOM query that generates a resolved BOM. The resolved BOM includes a subgroup of the data in the data set, with the data outside of the subgroup corresponding to a revision associated with an item object that is included in the subgroup. In this manner, the properties of the sections corresponding to the subgroup are determined. A further understanding of the nature and the advantages of particular embodiments disclosed herein may be realized by reference of the remaining portions of the specification and the attached drawings.

### BRIEF DESCRIPTION OF THE DRAWINGS

FIG. 1 is a simplified plan view of a computer system in which the current invention may be implemented;

FIG. 2 is a block diagram showing the interrelationship of different sections of a project for which information is stored on the computer system shown in FIG. 1;

FIG. 3 is a block diagram showing the configuration of a data set among a plurality of tables on the computer system shown in FIG. 1;

FIG. 4 is a detailed view of a BOM table shown in FIG. 3;

FIG. 5 is a block diagram showing the configuration of a data set among a plurality of tables on a computer system shown in FIG. 1 demonstrating the interrelationships of objects contained therein during data input;

FIG. 6 is plan view of an item table, shown in FIG. 3, with an example set of objects stored therein in accordance with one example of the present invention;

FIG. 7 is plan view of a change table, shown in FIG. 3, with an example set of objects stored therein in accordance with one example of the present invention;

FIG. 8 is plan view of a BOM table, shown in FIG. 3, with an example set of object stored therein in accordance with one example of the present invention;

FIG. 9 is a graphical representation showing the interrelationship of the object of data set during a business cycle;

FIG. 10 is a flow diagram showing one method of querying a data set shown in FIG. 3, in accordance with the present invention;

FIG. 11 is a plan view of a first graphical user interface employed in accordance with the present invention;

FIG. 12 is a plan view of a second graphical user interface employed in accordance with the present invention;

FIG. 13 is a plan view of the second graphical user interface shown in FIG. 12 showing different input parameters in accordance with the present invention;

FIG. 14 is a flow diagram showing one method of querying a data set shown in FIG. 3, in accordance with the an alternate embodiment of the present invention; and

FIG. 15 is a plan view of the first graphical user interface shown in FIG. 12 showing a different BOM resolution explosion parameters accordance with the present invention.

### DETAILED DESCRIPTION OF EMBODIMENTS

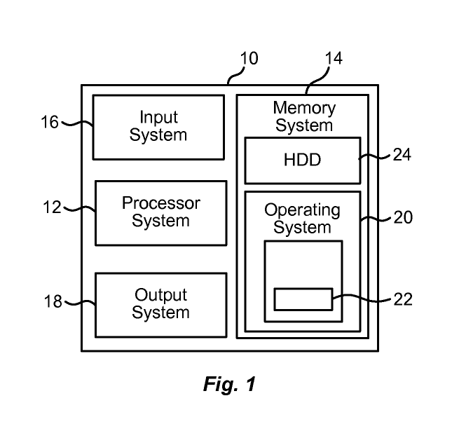

Referring to FIG. 1 in one embodiment the present invention is employed in a system 10 that includes a processor system 12, a memory system 14, a data input system 16, and a data output system 18. Processor system 12 may be any combination of one or more processors. Memory system 14 may be any combination of one or more memory devices, volatile, and/or non-volatile memory. Data input system 16 may be any combination of input devices, such as one or more keyboards, mice, trackballs, scanners, cameras, and/or interfaces to networks; and data output system 18, may be any combination of output devices, such as one or more monitors, printers, and/or interfaces to networks. A portion of memory system 14 is used to run an operating system 20 in which bill of material management (BOM) system 22 is executed.

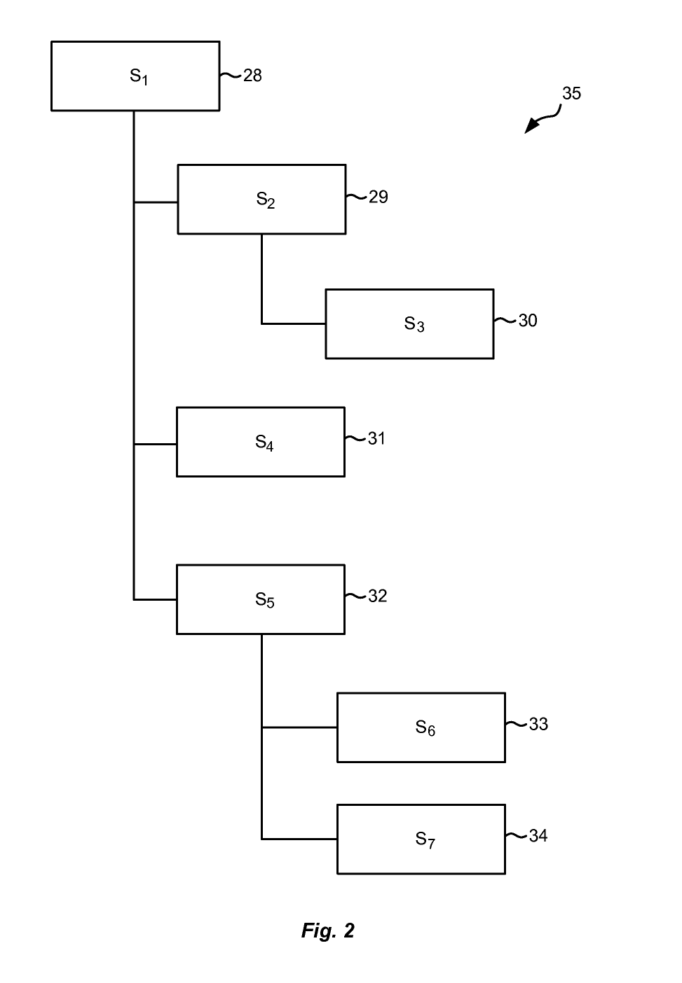

Referring to both FIGS. 1 and 2, BOM system 22 includes information corresponding to multiple sections 28-34 of a project 35. Project 35 may be any product or service provided in the course of business, such as those discussed in the background section. Project 35 is hierarchical in nature with section 28 representing a finished product 35 and sections 29-34 being sub-parts thereof, i.e., components and sub-assemblies. As a result, a subset of multiple sections, e.g., sections 29-34, provides descriptions of the properties defined by one the remaining sections outside of the subset, in this example section 28. It is possible that one of sections 29-34 provides descriptions for more than one of the remaining sections 28-34. For example, section 30 further defines the properties of sections 28 and 29. It is well understood that during the business cycle of project 35 many changes and/variations to the descriptions provided by sections 28-34 may occur. Moreover, the changes may or may not be in sequence of the corresponding business cycle to which project is applicable.

Referring to FIGS. 1, 2 and 3, BOM system 22 facilitates tracking changes to sections 28-34 during different sequences of a business cycle in view of changes/variations made thereto. In the present example BOM system 22 is discussed with respect to a development sequence of a business cycle. To that end, BOM system 22 include software code that may be developed in any known language, such as JAVA so as to provide a data set 26 arranged in a plurality of tables 36-41. Tables 36-41 are typically stored on computer readable tangible media, such as a hard disk drive 24 of memory system 14.

Table 36 is an item table, table 37 is a BOM table, table 38 is a change table and table 39 is a revision table. It should be understood that item table 36, BOM table 37, change table 38 and revision table 39 are logical tables. Tables 40 and 41 are optional and are employed to contain further information concerning the objects in item table 36. Although a single table is shown with respect to table 40, and a single table is shown with respect to table 41, in practice each of tables 40 and 41 may correspond to multiple tables containing other information. A logical table may be viewed as one representation of a data object, and the term table is used herein to simplify the conceptual description of objects and custom objects according to the present invention. As a result, it should be understood that “table” and “object” may be used interchangeably herein.

Item table 36 includes objects containing information concerning one of sections 28-34 that is static, i.e., does not undergo change during the business cycle of project 35. Change table 38 includes objects that indicate changes made to descriptions of sections 28-34. Revision table 39 associates objects of change table to items objects of item table 36 corresponding to the descriptions of sections 28-34 that underwent a change.

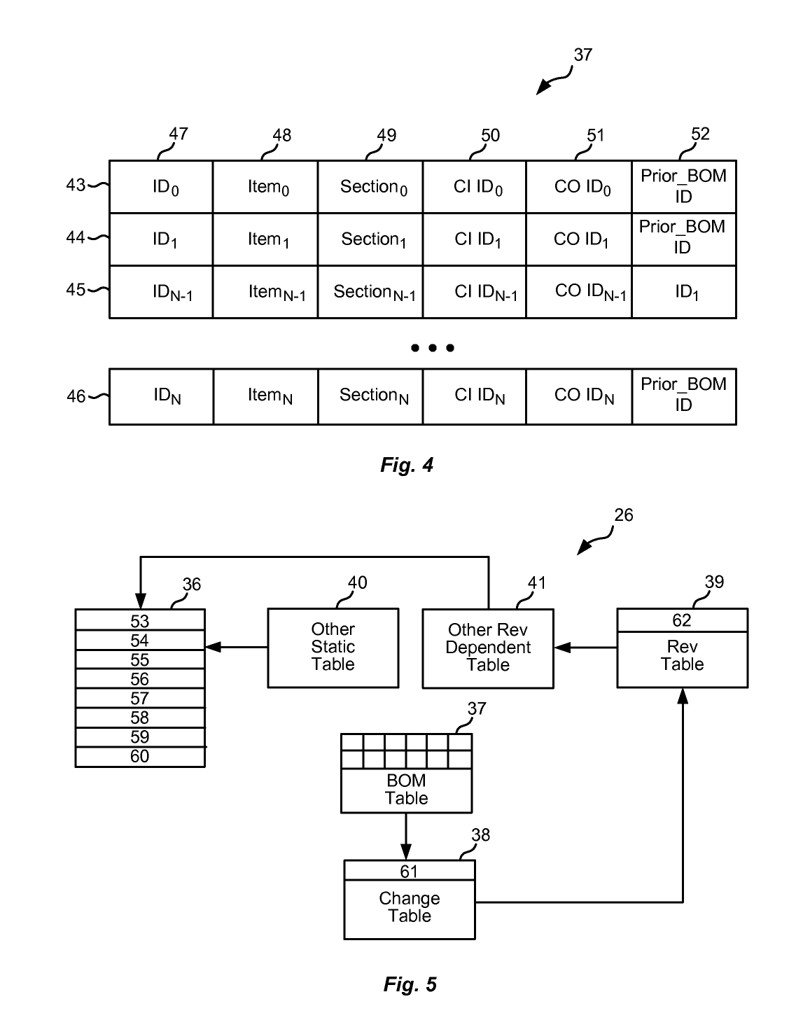

Referring to FIGS. 2, 3 and 4, BOM table 37 represents a relationship between sections 28-34 and information concerning the descriptions thereof contained in item table 36, change table 38 and revision table 39 during the development cycle. To that end, BOM table 37 points to both item table 36 and change table 38. Specifically, BOM table 37 includes a plurality of rows 43-46 each of which includes multiple fields that define columns 47-52. Column 47 is a row index and includes information corresponding to an identification of each row 43-46. The identification of each row 43-46 is different than the identification of the remaining rows in BOM table 37. Column 48 includes information corresponding to an identification of an item object in item table 36 for each row 43-46. It is possible that more than one row 43-46 corresponds to a common item object in item table 36. For a given row 43-46, column 49 includes information corresponding to the relationship between the information contained in column 48 and one of the items objects represented by information in column 48 of one a different row 43-46. In this manner, the hierarchal structure of project 35 is represented in BOM table 37. For example, information in row 44, column 49 is entitled SECTION₁ and may include information defining the relationship of the information in row 44, column 48 entitled ITEM₁ with the information in row 43, column 48 entitled ITEM₀. Column 50 includes an identification of a row in change table 38 that includes information describing changes to the description of an item object identified in column 48 for the corresponding row, including the segment of the business cycle during which the change commences. Column 51 includes an identification of a row in change table 38 that includes information describing the segment of the business cycle during which the change identified in column 50 of the same row 43-46 ceases. Column 52 identifies the row of BOM table 37 that is replaced by the current row. In this manner, column 52 functions as a means of indicating information in BOM table 37 that is to be ignored, i.e., are obsolete.

Referring to FIGS. 2, 3, 5 and 6, as mentioned above, item table 36 includes objects containing information concerning one of sections 28-34. More particularly, one of sections 28-34 may correspond to more than one item in item table 36. However, initially, each section 28-34 corresponds to one of item objects, shown as 53-59. Assume that item object 54 has a name Z_200 and corresponds to section 29. Assume that the parameters of section 29 were changed. This would be reflected by introduction of an additional item object 60 is used as a BOM component that corresponds to section 29. The description change of section 29 may be implemented by one of several procedures, including an engineering change order (ECO), a manufacturing change order (MCO), a site change order (SCO) and the like. In the current example, we shall assume that the change to the description of section 29 is implemented via an ECO_068, which is the name associated with the change in description in data set 26. This would result in a change object 61 being generated in change table 38 that includes the aforementioned name and a unique identifier of the change object corresponding to the name. In response to the change object being generated in change table 38, a revision object 62 is generated in revision table 39 that includes the unique identifier of the aforementioned change object and the identification of item object 54 to which change object 61 corresponds.

Assume that row 44 of table 37 corresponds to item object 54 before the aforementioned modifications to data set 26 were implemented. Column 50-52 would have a null value, because there would be no corresponding information contained in data set 26. Column 48 would include Z_200, the name of item object 54. Row 47 would include a unique row identification. Assume row 45 corresponds to the aforementioned changes to the description of section 29. Column 47 of row 45 would include a unique row identification. Column 48 would include Z_200, the name of item object 54. Column 49 would include the name of the new item object 60 included in item table 36. Column 50 would include the identification number of change object 61. Column 51 would include null information, because change object 61 had not been replaced by a subsequent change objection. Column 52 would include the identification of row 44, i.e., the information contained in column 47 of row 44. The information contained in column 52 of row 45 indicated that the row 44 corresponding to the identification in column 52 was to be ignored during a BOM resolution. Specifically, to implement a BOM resolution, BOM system 22 searches BOM table 37 in response to a BOM query to identify the appropriate descriptions of products by identifying the correct information contained in data set 26, discussed more fully below.

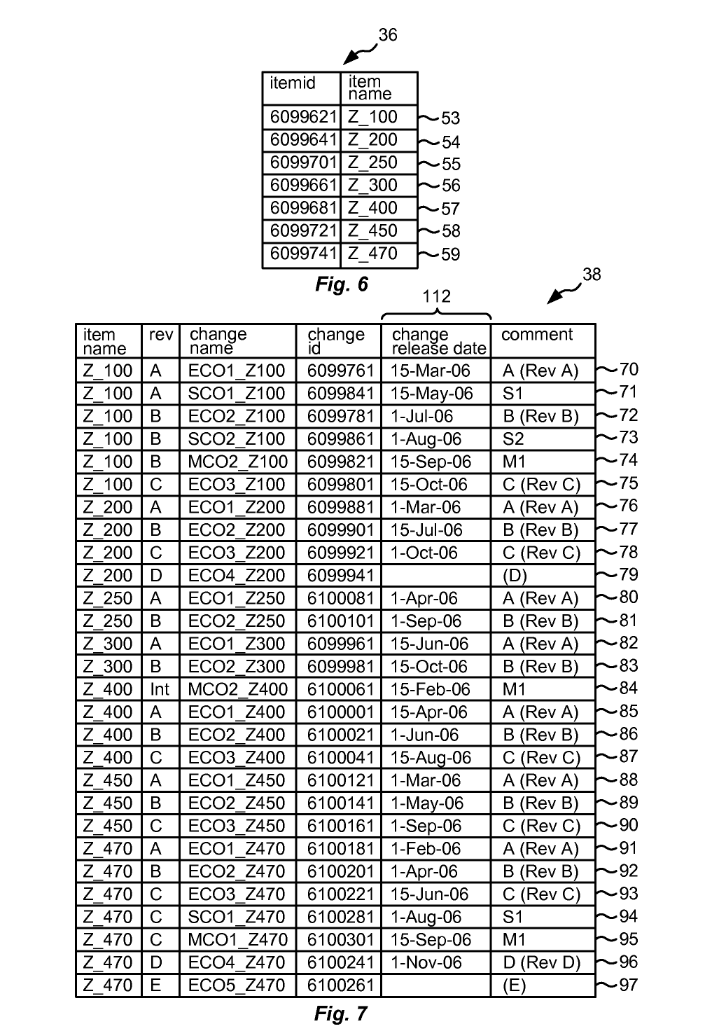

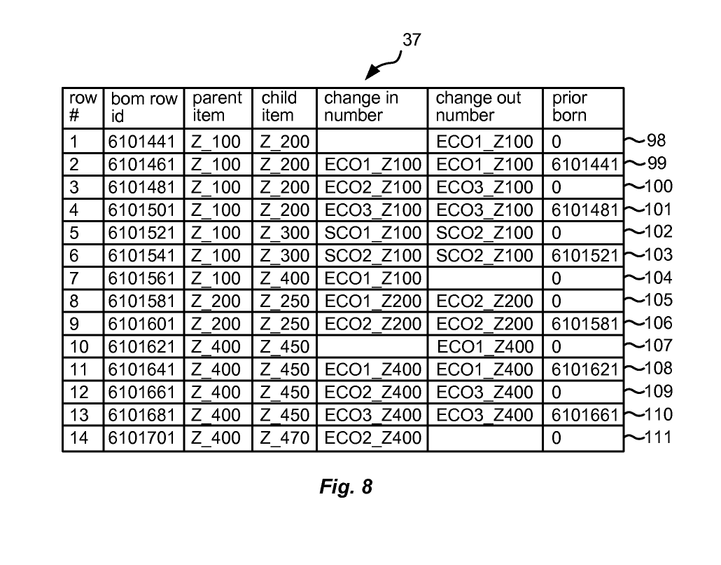

Referring to FIGS. 6-8, to more accurately describe the robustness of BOM system 22 assume item objects 53-59 are stored in item table 36 as follows: select id, item_number from item where item_number like ‘Z_%0’. Object 53 having item name Z_100 corresponds to section 28; object 54 having item name Z_200 corresponds to section 29; object 55 having item name Z_250 corresponds to section 30; object 56 having item name Z_300 corresponds to section 31; object 57 having item name Z_400 corresponds to section 32; object 58 having item name Z_450 corresponds to section 33; and object 59 having item name Z_470 corresponds to section 34.

In change table 38 there are 28 change objects shown as 70-97, stored as follows: select I.item_number as “item name”, decode(R.rev_number, null, ‘Int’, R.rev_number) as “rev”, C.change_number as “change name”, C.id as “change id”, C.release_date as “change release date” from change C, rev R, item I where C.change_number like ‘%_Z %0’ and C.id=R.change and R.item=I.id group by C.id, C. change_number, C.release_date, I.item_number, R.rev_number order by I.item_number, C.release_date.

For the foregoing objects BOM table 37 may be represented by 14 rows as follows: select B.id as “bom row id”, parentitem.item_number as “parent item”, childitem.item_number as “child item”, chgin.change_number as “change in number”, chgout.change_number as “change out number”, B.prior_bom as “prior bom” from bom B, change chgin, change chgout, item parentitem, item childitem where B.change_in=chgin.id and B.change_out=chgout.id and B.item=parentitem.id and B.component=childitem.id and B.item in (select id from item where item_number like ‘Z_%0’).

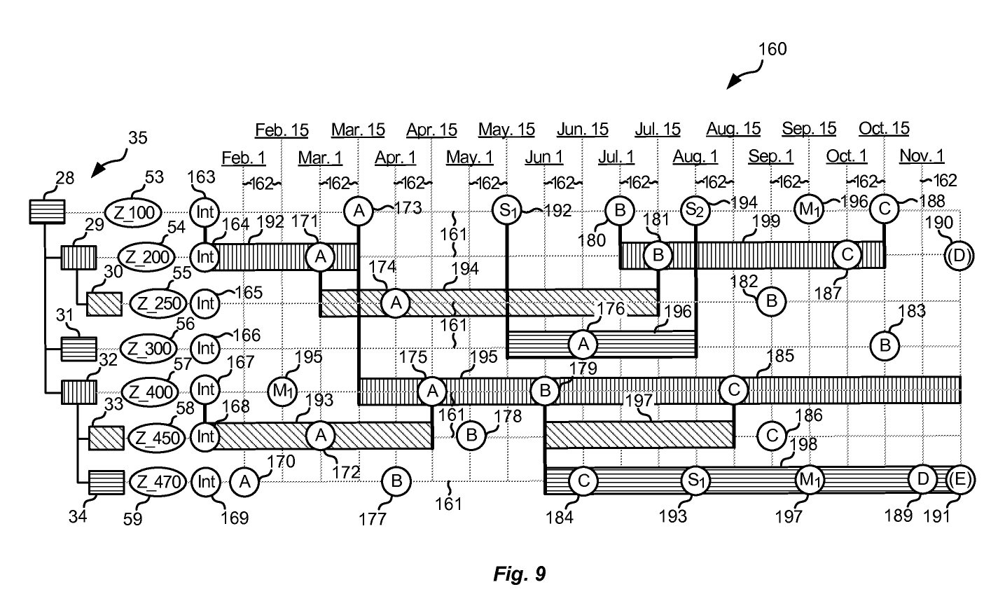

Referring to FIG. 9, a graphical representation of data set 26 mapped to a calendar is shown in graph 160. Shown on the left hand side are sections 28-34 of project 35 and corresponding objects 53-59. Each horizontal line 161 in graph 160 corresponds to one of item names Z_100, Z_200, Z_250, Z_300, Z_400, Z_450 and Z_470. Each vertical line 162 corresponds to a different calendar date. Each circular icon 163-169 labeled “int” indicates the initial object of data set 26 that corresponds to the description 28-34 that lies on a common horizontal line 161. For example, icon 163 corresponds to item Z_100 and represents information for section 28. Similarly, icon 164 corresponds to item Z_200 and represents information for section 29. Icons labeled “A”, 170-176, indicate a first revision of the initial object of data set 26 that corresponds to the description 28-34 that lies on a common horizontal line 161. Icons labeled “B”, 177-183, indicate a second revision of the initial object of data set 26 that corresponds to the description 28-34 that lies on a common horizontal line 161. Icons labeled “C”, 184-188, indicate a third revision of the initial object of data set 26 that corresponds to the description 28-34 that lies on a common horizontal line 161, and icons labeled “D”, 189 and 190, indicate a fourth revision of the initial object of data set 26 that corresponds to the description 28-34 that lies on a common horizontal line 161. Icons labeled “E”, 191, indicate a fifth revision of the initial object of data set 26 that corresponds to the description 28-34 that lies on a common horizontal line 161. Icons including an “S” in the label, 192-194, indicate a site change to the initial object of data set 26, which typically includes descriptions related to the geographic location/site in which project 35 is produced. The site change number follows the letter “S” to indicate the number of site changes for an initial data object. Icons including an “M” in the label, 195-197, indicate a manufacturing change to the initial object of data set 26 and typically includes descriptions related to the processes and/or component changes implemented to manufacture project 35. The manufacturing change number follows the letter “M” to indicate the number of manufacturing changes for an initial data object. Validity bars 192-199 indicate the dates during which items are valid, i.e., to be included in the description of project 35. For example, Z_200 is included in the description of item Z_100 from the initial object date, which may be arbitrarily chosen to be in the past, until March 15. Between March 15 and July 1, item Z_200 is omitted from the description of project 35, only to be included again during a period from July 1 to October 15, after which date item Z_200 is again omitted.

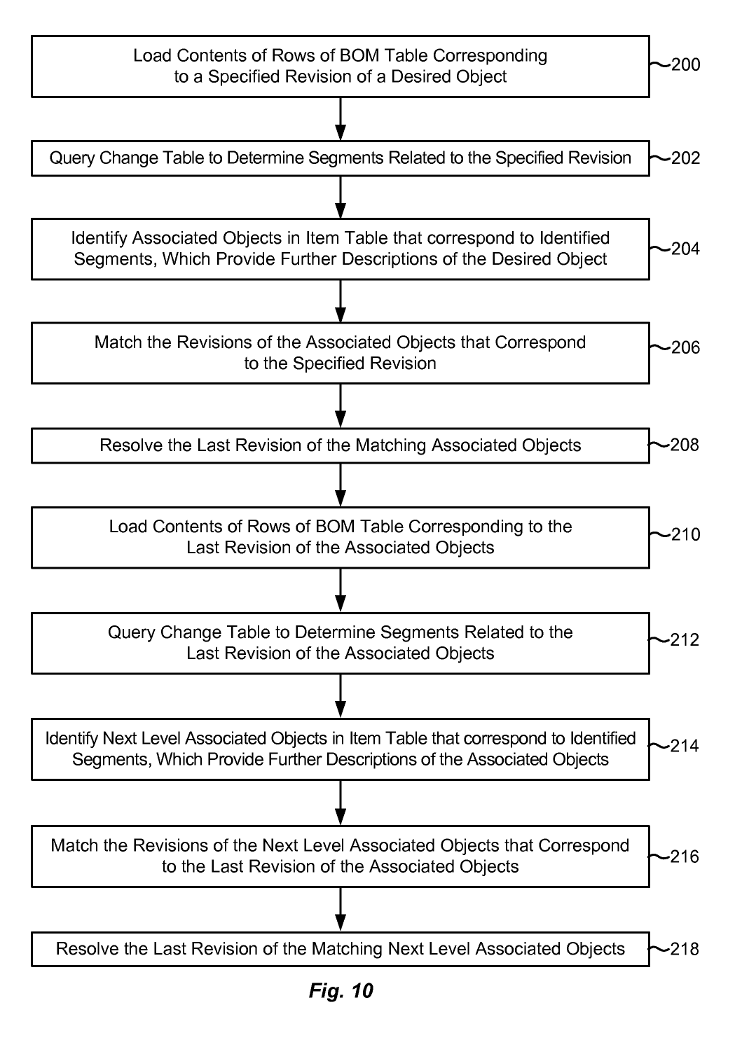

Referring to FIGS. 1, 3, 6-8 and 10, data set 26 facilitates efficient querying by BOM system 22 through avoiding manipulation of redundant and/or obsolete information contained in tables 36-41. Specifically, BOM system 22 is employed to facilitate determination of the properties of sections 28-34 as a function of different conditions. This is achieved by applying different search parameters to data set 26. For example, data set 26 may be employed to provide a BOM explosion report with search parameters of a particular revision of item number Z_100, e.g., revision A. To that end, BOM system 22 loads the contents of all rows corresponding to item=‘Z_100’ from BOM table 37, i.e., rows 98-104, at function 200. Change table 38 is queried to identify segments of the business cycle corresponding to revision A of item number Z_100 (ECO1_Z100) at function 202. Although any measure may be employed to establish segments of the business cycle, e.g., arbitrary units of measurements, in the present example calendar dates are employed as a segment. As a result, BOM system 22 identifies a period in a range of 15 Mar. 2006 to 15 May 2006, which is from the release date of revisions A to the release date of S1. BOM system 22 then identifies the contents of data set 26 that correspond to sections 29-34 that provides further descriptions of section 28 for the period of 15 Mar. 2006 to 15 May 2006 at function 204. This results in object 57 being identified having item name Z_400, which is represented by the seventh row 104 of BOM table 37, which indicates that the description of section 28 was changed by the description of section 32 that was implemented on 15 Mar. 2006 and is current as of the date of the query. It should be understood that objects 58 and 59 are ignored during this resolution, as are objects 29-31.

Next, BOM system 22 matches the revisions of object 57 that correspond to revision A of object 53 at function 206. To that end, BOM system 22 identifies the period during which revision A of object 53 is in force, referred to as an effective period of revision A of object 53. The effective period is 15 Mar. 2006 to 1 Jul. 2006, i.e., the period from the release date of revision A to the release date of revision B, the date upon which revision A is no longer valid. Following this, BOM system 22 resolves the last revision of Z_400, which is revision B, at function 208.

BOM system 22 then identifies all revisions object 57 that are in force concurrently with revision A of object 53. As a result, BOM system 22 identifies four effective periods, each of which corresponds to a different revision of object 57. The first effective period is from some arbitrary date in the past, e.g., 1 Jan. 1970, to the release date of revision A of object 57, 15 Apr. 2006. The second effective period is from 15 Apr. 2006, the release date of revision A to the release date of revision B of object 57, 1 Jun. 2006. The third effective period is from the release date of revision B, 1 Jun. 2006, to the release date of revision C, 15 Aug. 2006. The fourth effective period is from the release date of revision C to the date of the present query. BOM system 22 next identifies overlap between the effective period of revision A of object 53 and the four aforementioned effective periods for the different revisions of object 57. From this BOM system 22 identifies three corresponding revisions of object 57 that were valid during the overlap from which is obtained the resolved description of section 32, revision B (ECO2_Z400) at function 208.

Next all rows from BOM table 37 for item=‘Z_400’ are identified, i.e., rows 107-111 of function 210. Change table 38 is queried to retrieve the change effective period for revision B of object 57, 1 Jun. 2006 to 15 Aug. 2006 at function 212. This period corresponds to the release date of revision B to the release date of revision C of object 57. BOM system 22 identifies all object of item table 36 in force concurrently with revision B of object 57. This yields objects 58 and 59. Specifically, the content in rows 109 and 111 are identified. Row 109 indicates that object 58 is added to object 57 on 1 Jun. 2006 and is maintained until 15 Aug. 2006. Row 111 indicates that object 59 is added to object 57 on 1 Jun. 2006 and is currently active. BOM system 22 identifies the effective period for revision B of object 57 as being 1 Jun. 2006 to 15 Aug. 2006 and all revisions of object 58 that are in force concurrently with revision B of object 57. Four effective periods are identified, each of which corresponds to a different revision of object 58. The first effective period is from some arbitrary date in the past, e.g., 1 Jan. 1970, to the release date of revision A of object 58, 1 Mar. 2006. The second effective period is from 1 Mar. 2006, the release date of revision A, to the release date of revision B of object 58, 1 May 2006. The third effective period is from the release date of revision B, 1 May 2006, to the release date of revision C, 1 Sep. 2006. The fourth effective period is from the release date of revision C to the date of the present query. In a similar manner, BOM system 22 identifies all revisions object 59 that are in force concurrently with revision B of object 57. This results in five effective periods. The first effective period is from some arbitrary date in the past, e.g., 1 Jan. 1970, to the release date of revision A of object 59, 1 Feb. 2006. The second effective period is from 1 Feb. 2006, the release date of revision A, to the release date of revision B of object 59, 1 Apr. 2006. The third effective period is from the release date of revision B, 1 Apr. 2006, to the release date of revision C, 15 Jun. 2006. The fourth effective period is from the release date of revision C to the 1 Nov. 2006, the release date of revision D of object 59. The fifth effective period is from the release date of revision D to the date of the present query. BOM system 22 next identifies a match between the effective period of revision B of object 57 and the aforementioned effective periods for each of objects 58 and 59 at function 216. From this BOM system 22 identifies one corresponding revision of object 58 is valid during the overlap and two revisions of object 59. BOM system 22 then resolves description of sections 33 and 34 as being revision B (ECO2_Z450) and M1 (MCO1_470) on revision C, respectively at function 218.

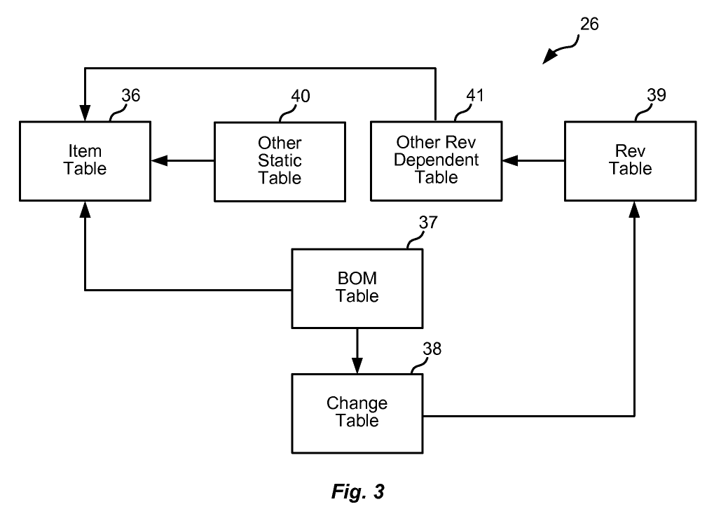

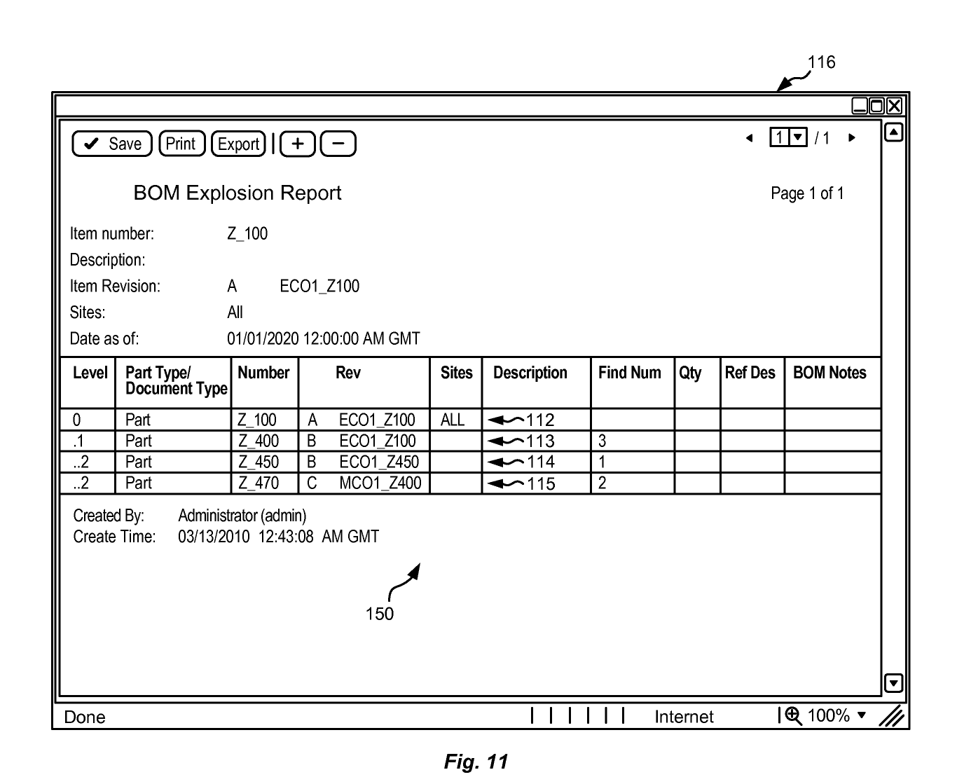

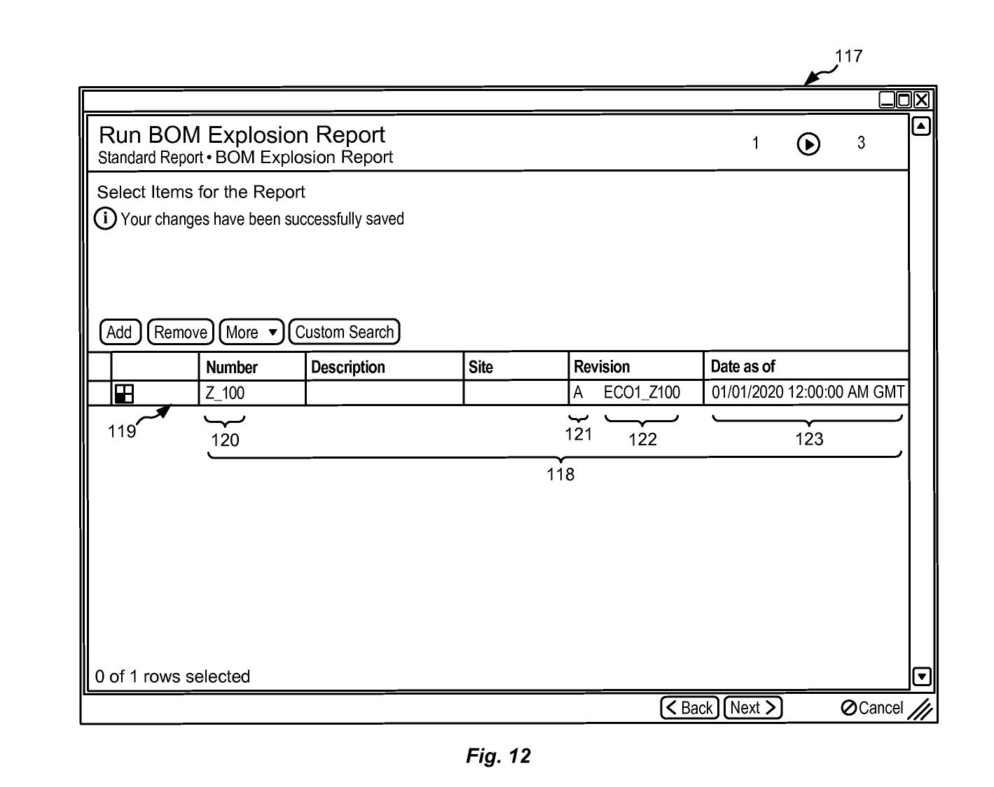

The resolution described above is typically shown on output system 18 of computer 10, shown in FIG. 11. Each item 53, 57, 58 and 59 are represented in data fields 112, 113, 114 and 115 on graphical user interface 116. Data fields 112-115 are arranged in a tree structure so as to visibly represent a parent-child relationship. As shown, information contained data filed 112 is the parent of the information contained in data fields 113, 114 and 115. The information in data fields 113, 114 and 115 represents objects 57 and 58 and 59, which correspond to sections 32, 33 and 34, respectively. This is referred to as a BOM explosion resolution 150. GUI 117, shown in FIG. 12, is employed to receive input parameters 118 that define a BOM query. BOM system 22 employs the input parameters 118 to manipulate data set 26 and produce BOM explosion resolution 150. To that end, a data entry box 119 is included in GUI 117 includes an item_id 120 input parameter, a revision_id input parameter 121, a chang_id input parameter 122 and a date input parameters 123. It should be understood that these parameters are examples of parameters than may be employed to query data set 26, shown in FIG. 3

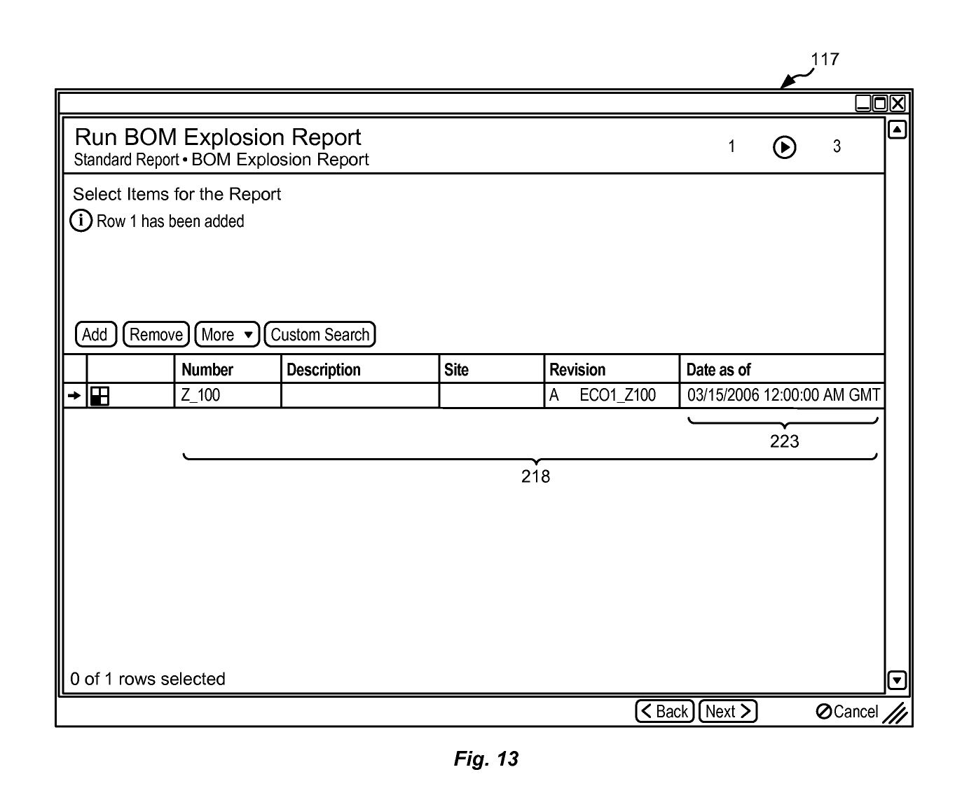

Referring to FIGS. 1, 12 and 13, BOM system 22 may resolve data set based upon a particular segment of the business cycle for a particular item. In the present example, the item name is Z_100 and the particular segment is a calendar date 15 March. This may be seen by review of GUI 117 in which input parameters 218 of the BOM query are identical to input parameters 118, excepting the data input parameters 223.

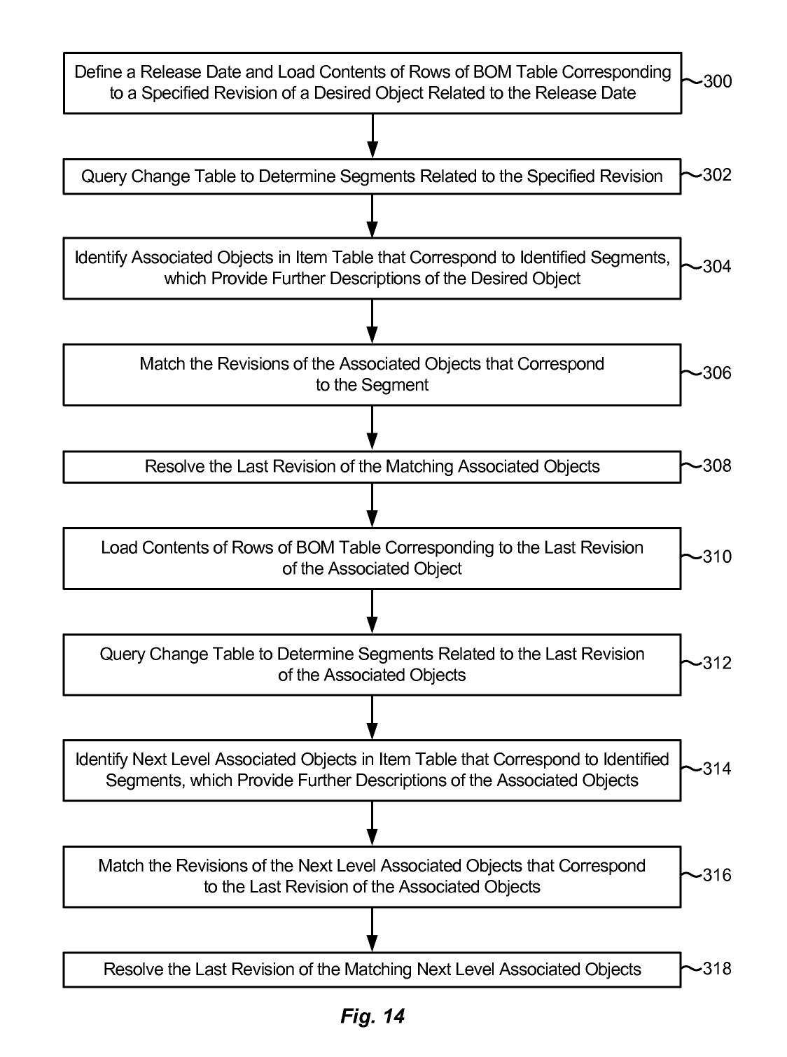

Referring to FIGS. 1, 6-8, 13 and 14, in respect to input parameters 218, BOM system 22 loads contents of all rows corresponding to item=‘Z_100’ from BOM table 37, i.e., rows 98-104, at function 300. Change table 38 is queried to identify segments of the business cycle corresponding to the revision item number Z_100 (ECO1_Z100) that is valid as of March 15, revision A at function 302. BOM system 22 then identifies the contents of data set 26, associated objects, corresponding to sections 29-34 that provides further descriptions of section 28 on 15 Mar. 2006, at function 304. This results in object 57 being identified having item name Z_400, which is represented by the seventh row of BOM table 37. Next, at function 306, BOM system 22 matches the revisions of the associated objects, object 57 in this example, that correspond to the segment of the business cycle. In this example, the segment is a release date. Following this, at function 308, BOM system 22 resolves the last revision of Z_400, of the associated objects, that is valid during both revision A of object 28 and as of the date 15 Mar. 2006. This yields change M1 (MCO1_Z400).

Next all rows from BOM table 37 for item=‘Z_400’ are identified, i.e., rows 107-111 of function 310 in the same manner as discussed with respect to function 210. At function 312, change table 38 is queried to determine the segment of the business cycle correspond to the effective period for M1 (MCO1_Z400) of object 57, 15 Feb. 2006 to 15 Apr. 2006, the release date of M1 (MCO1_Z400) to the release date of revision A of object 57. BOM system 22 identifies the next level associated objects of item table 36 in force concurrently with the M1 (MCO1_Z400) change of object 57 at function 314. This yields object 58. Specifically, the content in row 107 is identified. Row 107 indicates that object 58 is added to object 57 and remains valid until 15 Apr. 2006. BOM system 22 identifies the effective period for the initial object 57, which is the status of object 57 when M1 (MCO1_Z400) is introduced to 15 Apr. 2006, the release date of revision A of object 57. BOM system 22 identifies all effective periods from object 58, which yields four effective periods. Four effective periods are identified, each of which corresponds to a different changes revision of object 58. The first effective period is from some arbitrary date in the past, e.g., 1 Jan. 1970, to the release date of revision A of object 58, 1 Mar. 2006. The second effective period is from 1 Mar. 2006, the release date of revision A, to the release date of revision B of object 58, 1 May 2006. The third effective period is from the release date of revision B, 1 May 2006, to the release date of revision C, 1 Sep. 2006. The fourth effective period is from the release date of revision C to the date of the present query. BOM system 22 next identifies an overlap between the effective from the initial revision of object 57 and aforementioned effective periods for each of object 58 and matches any changes to object 58 in the overlap, function 316. Two are found, the initial revision of object 58 and revision A.

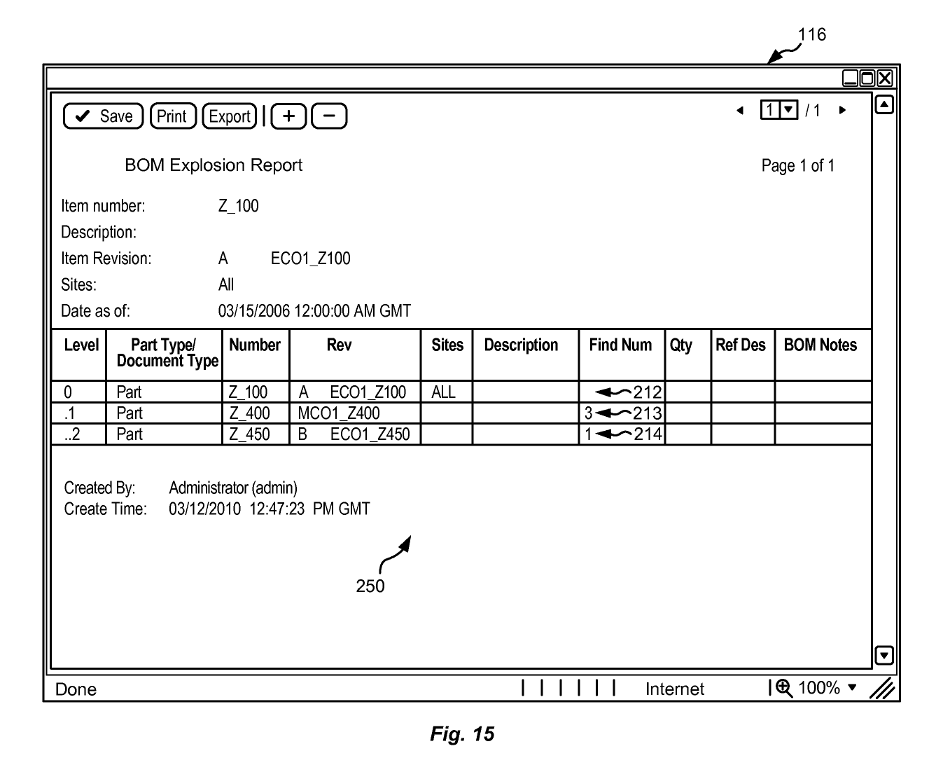

Finally, BOM system 22 resolves the last changes to object 58 previously identified, which is revision A, (ECO1_Z450), at function 318. This provides the BOM explosion resolution 250 shown in FIG. 15. Data fields 213 and 214 include information that is different from the information contained is the corresponding data fields 113 and 114 for BOM explosion resolution 150. Additionally, there is no data field in BOM explosion resolution 250 that correspond to data field 115 in BOM explosion resolution. This results from the different data parameters used in the BOM query. Specifically, BOM system 22 compares the data parameters to the current date of system 10 and if it is determined that data parameter is a future date, i.e., has not yet occurred, data parameter is ignored for purposes of producing a BOM resolution explosion. As a result, date parameter 123, shown in FIG. 12 was ignored by BOM system 22.

An advantage presented by resolving a bom with a BOM query that identifies a specific segment of the business cycle, e.g., a date, is that it facilitates resolving a BOM for unreleased changes. Specifically, each of the aforementioned revisions are assumed to be a released revision, i.e., a revision for which authorization had been received to modify the description of product 35 in accordance therewith. This may be observed by viewing column 112 which contains information that functions as a release authorization. However, resolving data set 26 based upon the parameters of item name and revision, precludes one from resolving for unreleased changes, because unreleased changes are ignored by BOM system 22, unless a date query is included. To that end, in an alternate embodiment of the invention, a BOM query would include at least the following parameters, an item name, a calendar date, and a change id.

It should be borne in mind that the foregoing description in an example of the embodiments and that modification and changes may be made thereto while staying within the scope of the invention and should be interpreted as limiting the scope thereof. Rather, the scope of the invention should be interpreted by the broadest interpretation of the claims recited herein, including the full scope of equivalents.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A product lifecycle management method comprising:
storing on a computer system a data set arranged in a plurality of tables that correspond to multiple sections of a project, with each of the multiple sections defining properties of said project and a subset of said multiple sections providing descriptions of said properties defined by one of said multiple sections outside of said subset, with a first of said plurality of tables including item objects providing a description of the sections a second of said plurality of tables having change objects indicating variations made to the description, and a third of said plurality of tables defining relationships between said change object and said item object in relation to a development sequence of said project;
producing a BOM resolution by querying said data set in response to parameters of a BOM query to produce a resolved BOM that includes a subgroup of the data in said data set, with the data outside of said subgroup corresponding to a revision associated with an item object that is included in said subgroup; and
determining, from said subgroup, properties of the sections.

2. The method as recited in claim 1 wherein producing further includes introducing the parameters that include an item name and an identification of a segment of a business cycle.

3. The method as recited in claim 1 wherein producing further includes introducing the parameters that include an item name, a revision associated with said item name and an identification of a segment of a business cycle.

4. The method as recited in claim 1 wherein the producing further includes determining whether the data of the subgroup is associated with a release authorization.

5. The method as recited in claim 1 wherein the producing further includes identifying a sub-part of said items objects corresponding to a segment of a development sequence.

6. The method as recited in claim 1 wherein the producing further includes identifying a sub-part of said items objects corresponding to a segment of a development sequence and determining whether said sub-part are associated with a release authorization

7. The method as recited in claim 1 wherein said data set corresponds to a development sequence of the project having a plurality of segments.

8. The method as recited in claim 1 wherein said data set corresponds to a development sequence of the project having a plurality of segments, with and each of the plurality of segments corresponding to a calendar date.

9. The method as recited in claim 1 wherein said data set corresponds to a development sequence of the project having a plurality of segments, with and each of the plurality of segments corresponding to a range of calendar dates and the producing further includes determining the subgroup is associated with a release authorization.

10. An apparatus comprising:
one or more processors; and
logic encoded in tangible media for execution by the one or more processors and when executed operable to:
store on a computer system a data set arranged in a plurality of tables that correspond to multiple sections of a project, with each of the multiple sections defining properties of said project and a subset of said multiple sections providing descriptions of said properties defined by one of said multiple sections outside of said subset, with a first of said plurality of tables including item objects providing a description of the sections a second of said plurality of tables having change objects indicating variations made to the description, and a third of said plurality of tables defining relationships between said change object and said item object in relation to a development sequence of said project;
produce a BOM resolution by querying said data set in response to parameters of a BOM query to produce a resolved BOM that includes a subgroup of the data in said data set, with the data outside of said subgroup corresponding to a revision associated with an item object that is included in said subgroup; and
determine, from said subgroup, properties of the sections.

11. The apparatus of claim 10 further including a computer monitor and wherein the logic when executed is further operable to:
display upon the computer monitor a data entry screen and receive through the data entry screen the parameters, with the parameters including an item name and an identification of a segment of a business cycle.

12. The apparatus of claim 10 further including a computer monitor and wherein the logic when executed is further operable to:
display upon the computer monitor a data entry screen and receive through the data entry screen the parameters, with the parameters including an item name, a revision associated with said item name and an identification of a segment of a business cycle.

13. The apparatus of claim 10 wherein the logic when executed is further operable to:
correspond said data set corresponds to a development sequence of the project that has a plurality of segments.

14. The apparatus of claim 10 wherein the logic when executed is further operable to:
correspond said data set to a development sequence of the project that has a plurality of segments, with and each of the plurality of segments corresponding to a calendar date.

15. The apparatus of claim 10 wherein the logic when executed is further operable to:
correspond said data set to a segment of a development sequence and determining whether said sub-part are associated with a release authorization

16. The apparatus of claim 10 wherein the logic when executed is further operable to:
correspond said data set s to a development sequence of the project that has a plurality of segments, with and each of the plurality of segments corresponding to a range of calendar dates and the producing further includes determining whether the subgroup is associated with a release authorization.

17. A machine-readable medium carrying one or more sequences of instructions for managing data when executed by one or more processors and cause the one or more processors to carry out the steps of:
storing on a computer system a data set arranged in a plurality of tables that correspond to multiple sections of a project, with each of the multiple sections defining properties of said project and a subset of said multiple sections providing descriptions of said properties defined by one of said multiple sections outside of said subset, with a first of said plurality of tables including item objects providing a description of the sections a second of said plurality of tables having change objects indicating variations made to the description, and a third of said plurality of tables defining relationships between said change object and said item object in relation to a development sequence of said project;
producing a BOM resolution by querying said data set in response to parameters of a BOM query to produce a resolved BOM that includes a subgroup of the data in said data set, with the data outside of said subgroup corresponding to a revision associated with an item object that is included in said subgroup; and
determining, from said subgroup, properties of the sections.

18. The machine readable medium of claim 17 wherein the instructions further include a subroutine when executed by the one or more processors causes the one or more processor to carry out the step displaying upon a computer monitor a data entry screen wherein the instructions to carry out the step of producing further includes instructions to receive through the data entry screen the parameters, with the parameters including an item name and an identification of a segment of a business cycle.

19. The machine readable medium of claim 17 wherein the instructions further include a subroutine when executed by the one or more processors causes the one or more processor to carry out the step displaying upon a computer monitor a data entry screen wherein the instructions to carry out the step of producing further includes instructions to receive through the data entry screen the parameters, with the parameters including an item name, a revision associated with said item name and an identification of a segment of a business cycle.

20. The machine readable medium of claim 17 wherein the instructions to carry out the step of producing further includes instructions to carry out the steps of identifying a sub-part of said items objects corresponding to a segment of a development sequence and determining whether said sub-part are associated with a release authorization.
